(19) United States
(12) Patent Application Publication
(10) Pub. No.: US 2024/0253098 A1
(43) Pub. Date: Aug. 1, 2024

(54) CONVERSION OF MINE WASTE MATERIALS INTO SUPPLEMENTARY CEMENTITIOUS MATERIALS

(71) Applicant: CR Minerals Company, LLC, Fort Worth, TX (US)

(72) Inventors: Joseph Earl THOMAS, Malad City, ID (US); Jeffrey Alexander WHIDDEN, Keller, TX (US)

(21) Appl. No.: 18/427,241

(22) Filed: Jan. 30, 2024

Related U.S. Application Data
(60) Provisional application No. 63/442,341, filed on Jan. 31, 2023.

(51) Int. Cl. B09B 3/40; B09B 3/35; C04B 18/04

(52) U.S. Cl. CPC B09B 3/40; B09B 3/35; C04B 18/0481

(57) ABSTRACT

This invention repurposes mining waste/gangue materials to produce valuable supplementary cementitious materials, such as pozzolans for concrete applications. A process for producing a supplementary cementitious material from a mine waste material, comprises: obtaining a mine waste material; crushing the mine waste material; milling the crushed mine waste material to enhance pozzolanicity via mechanical activation; optionally, calcining or sintering the crushed mine waste material to generate a calcined/sintered mine waste material that is thermally activated to enhance pozzolanicity; optionally, milling the calcined/sintered mine waste material; and recovering a supplementary cementitious material, which may contain a separate pozzolan added at some point in the process. Experimental results demonstrate the disclosed technology for upcycling mining waste materials in the form of overburden, reject materials, and production byproducts, into supplementary cementitious materials. This discovery provides significant benefits to concrete performance and durability, while also substantially lowering the carbon footprint of the concrete.

### PRIORITY DATA

This patent application is a non-provisional application claiming priority to U.S. Provisional Patent App. No. 63/442,341, filed on Jan. 31, 2023, which is hereby incorporated by reference herein.

### FIELD OF THE DISCLOSURE

The present disclosure generally relates to methods of converting mine waste materials into useful pozzolanic compositions and supplementary cementitious materials, and products obtained therefrom.

### BACKGROUND OF THE DISCLOSURE

Molten lava, flash frozen upon explosive expulsion from the volcanic vent, instantly became what the Romans called “pozzolana”—pumice-based natural pozzolan, the key ingredient in Roman concrete. Roman structures such as aqueducts and roads used pulverized volcanic ash as pozzolan in their concrete. Concretes using natural (pumice) pozzolan have been proven to last thousands of years. Pozzolans fortify concrete, providing protection by mitigating various forms of chemical attack such as alkali-silica reaction (ASR), sulfate-induced expansion, efflorescence, as well as rebar oxidation and debondment caused by the ingress of chlorides. Pozzolans also densify concrete, reducing porosity and permeability, thereby reducing chemical ingress and increasing long-term compressive strength and durability.

Pumice pozzolan, and all volcanic pozzolans, are a type of natural pozzolan (NP). In the cement and concrete industries, NPs are a subset of supplementary cementitious materials (SCMs) which are used to replace cement in concrete mix designs. When replacing cement with SCM, the concrete's carbon footprint is significantly reduced and the concrete's durability is enhanced. Besides NPs, other forms of SCM include coal ash (including fly ash and bottom ash), slag, silica fume, and assorted manufactured pozzolans which may or may not come under the category of NPs.

Driven by the need to dispose of the ash scrubbed from the stacks of coal-fired power plants, the power industry discovered the residual ash had similar chemistries to natural pozzolans—a type of artificial pozzolan. The cement/concrete industries soon transitioned from natural pozzolans to fly ash due to cost and availability. Fly ash, especially Class F fly ash, played the role of a natural pozzolan replacement for many decades. However, the number of active coal-fired power plants is in steady decline. Many existing coal plants have been converted to natural gas.

There is a serious commercial need for new sources of pozzolans, and generally supplementary cementitious materials, for concrete applications. Preferably, these new supplementary cementitious material will come from waste streams that can be repurposed and recycled in order to lower the carbon footprint of cement and concrete, providing significant benefits by enabling a circular economy.

### SUMMARY OF THE DISCLOSURE

Some variations provide a process for producing a supplementary cementitious material from a mine waste material, the process comprising:
(a) obtaining a mine waste material containing a pozzolanic component, a pre-pozzolanic component, or a combination thereof;
(b) crushing the mine waste material to reduce the particle size, thereby generating a crushed mine waste material with an average particle size selected from about 0.1 millimeters to about 50 millimeters;
(c) optionally, calcining or sintering the crushed mine waste material at a first calcining or sintering temperature selected from about 600° C. to about 1600° C. and a first calcining or sintering time selected from about 1 second to about 10 hours;
(d) milling the crushed mine waste material or a calcined form thereof, to further reduce particle size, thereby generating a milled mine waste material with a median particle size (D50) selected from about 1 micron to about 50 microns;
(e) optionally, calcining or sintering the milled mine waste material at a second calcining or sintering temperature selected from about 600° C. to about 1600° C. and a second calcining or sintering time selected from about 1 second to about 10 hours;
(f) optionally, introducing a separate pozzolan to the mine waste material, the crushed mine waste material or a calcined/sintered form thereof, the milled mine waste material or a calcined/sintered form thereof, or a combination thereof; and
(g) recovering the milled mine waste material or a calcined/sintered form thereof as a supplementary cementitious material, wherein the supplementary cementitious material contains the separate pozzolan if step (f) is conducted.

In some embodiments, the mine waste material is a waste overburden material. In some embodiments, the mine waste material is a waste gangue material. In some embodiments, the mine waste material is a reprocessed waste material. In some embodiments, the mine waste material is a blend of at least two of a waste overburden material, a waste gangue material, and a reprocessed waste material. In certain embodiments, the mine waste material is a blend of a waste overburden material, a waste gangue material, and a reprocessed waste material.

In some embodiments, the supplementary cementitious material recovered in step (g) is blended or interground with uncalcined waste overburden material, uncalcined waste gangue material, uncalcined reprocessed waste material, or an uncalcined combination thereof.

In some embodiments, the mine waste material is obtained from mining of borax, lithium, gold, silver, platinum, palladium, rhodium, molybdenum, copper, nickel, aluminum, iron, zinc, phosphorous, silica, sand, clay, slate, shale, and combinations thereof.

In some embodiments, in step (d), the milling mechanically activates the crushed mine waste material to increase pozzolanicity.

In some embodiments in which step (c) is performed, the calcining or sintering thermally activates the crushed mine waste material to increase pozzolanicity.

In some embodiments in which step (e) is performed, the calcining or sintering thermally activates the milled mine waste material to increase pozzolanicity.

In some embodiments, step (e) is performed, and the process further comprises milling a calcined or sintered form of the milled mine waste material, thereby generating a milled calcined or sintered mine waste material with a median particle size (D50) selected from about 1 micron to about 50 microns.

In some embodiments, step (f) is performed, and the separate pozzolan is selected from the group consisting of natural pozzolans, coal fly ash, coal bottom ash, silica fume, ground granulated blast-furnace slag, diatomaceous earth, zeolites, metakaolin, and combinations thereof, for example.

In some embodiments, step (f) is performed, and the separate pozzolan meets a pozzolan specification under ASTM, ACI, and/or AASHTO. In other embodiments, the separate pozzolan is a non-spec pozzolan that does not meet a pozzolan specification under ASTM, ACI, or AASHTO.

In some embodiments, in step (b), the average particle size is selected from about 0.5 millimeters to about 25 millimeters, such as from about 1 millimeter to about 10 millimeters.

In some embodiments, in step (d), the median particle size (D50) is selected from about 2 microns to about 25 microns, such as from about 10 microns to about 20 microns.

In some embodiments in which step (c) is conducted, the first or sintering calcining temperature may be selected from about 700° C. to about 1200° C., and the first calcining or sintering time may be selected from about 2 seconds to about 5 hours.

In some embodiments in which step (e) is conducted, the second calcining or sintering temperature may be selected from about 700° C. to about 1200° C., and the second calcining or sintering time may be selected from about 2 seconds to about 5 hours.

The supplementary cementitious material preferably has a 7-day strength activity index SAI of at least 75%. Also, the supplementary cementitious material preferably has a 28-day strength activity index SAI of at least 75%.

In preferred embodiments, the supplementary cementitious material is a pozzolan pursuant to ASTM, ACI, and/or AASHTO.

In some embodiments, the supplementary cementitious material contains borax. In some embodiments, the supplementary cementitious material contains lithium. In certain embodiments, the supplementary cementitious material contains lithium and borax.

In various embodiments, the supplementary cementitious material contains gold, silver, platinum, palladium, rhodium, molybdenum, copper, nickel, aluminum, iron, zinc, phosphorous, silica, sand, clay, slate, shale, or a combination thereof.

The supplementary cementitious material may be used in concrete, mortar or grout applications intended to supplement, replace, or enhance cement, such as portland cement, blended cements, or ASTM C1157 cements. The supplementary cementitious material may be blended with fly ash, bottom ash, slag, or any other cementitious material, or supplementary cementitious material for various applications.

### BRIEF DESCRIPTION OF THE FIGURES

FIG. 1 shows a table of data for various experiments in Example A, testing different supplementary cementitious materials produced from mine waste materials.

FIG. 2 shows an ASTM C618-19 compliance certificate for calcined mudbird gangue in Example A, showing that the processed gangue meets the specification for a ASTM C618 class N pozzolan.

FIG. 3 shows a table of data for various experiments in Example B, testing different supplementary cementitious materials produced from a mine waste material.

FIG. 4 shows an ASTM C618-19 compliance certificate for calcined and milled analcime in Example B, showing that the processed analcime meets the specification for a ASTM C618 class N pozzolan.

### DETAILED DESCRIPTION OF EMBODIMENTS

Certain embodiments of the present disclosure will now be further described in more detail, in a manner that enables the claimed invention to be understood so that a person of ordinary skill in this art can make use of the present disclosure.

Unless otherwise indicated, all numbers expressing reaction conditions, concentrations, yields, and so forth used in the specification and claims are to be understood as being modified in all instances by the term “about.” Accordingly, unless indicated to the contrary, the numerical parameters set forth in the following specification and attached claims are approximations that may vary depending at least upon the specific analytical technique. Any numerical value inherently contains certain errors necessarily resulting from the standard deviation found in its respective testing measurements.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this disclosure belongs. If a definition set forth in this section is contrary to or otherwise inconsistent with a definition set forth in patents, published patent applications, and other publications that are incorporated by reference, the definition set forth in this specification prevails over the definition that is incorporated herein by reference.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of.”

Some variations of the present invention are predicated on the discovery that mining waste materials in the form of overburden, reject materials, and primary production byproducts can be reprocessed or upcycled to perform as supplementary cementitious materials in concrete. This discovery provides significant benefits to concrete performance and durability, while also substantially lowering the carbon footprint of the concrete.

The present invention provides a unique supplementary cementitious material (“SCM”) produced from waste mine materials, including spent processed ore, known as gangue or tailings, or waste mine overburden. Up to now, such materials had no further use and were stockpiled, usually near the mine site. Such sites, usually known as gangue dumps or waste piles, require extensive resources such as land, water (for dust control), equipment for placement and maintenance, and monitoring equipment to insure proper containment. These waste piles or dumps also preclude the use of the site for additional mining or other land use and often require extensive reclamation and expense. Utilizing the present invention to convert, repurpose, or recycle these materials into a valuable cementitious material allows for the replacement of cement, which significantly contributes to greenhouse gas emissions, with a repurposed waste that has a significantly lower carbon footprint than the material being replaced.

Provided herein are supplementary cementitious materials developed from the stockpiles of mine waste materials, including overburden and gangue/tailings, from mining operations. Also provided are methods to convert the waste materials into valuable cementitious products, thereby repurposing spent processed or mined materials.

Also provided are blends and compositions of various types of waste materials designed to create an optimized supplementary cementitious material, including blends with off-site spec and/or non-spec SCMs.

The mine waste materials, either singly or in blends, are selected based on their unusual chemical composition and physical properties for precision milling and/or thermoprocessing, to enhance their chemical reactivity in a cementitious mix design. The resulting cementitious material not only allows for the replacement of ordinary portland cement—a material well-known for its high carbon footprint and greenhouse gas emissions—thus significantly reducing the carbon footprint of concrete, but also adds to the chemical resistance and durability of concrete. By extending the useable lifespan of concrete infrastructure and by replacing a high-carbon-footprint material (ordinary portland cement), the disclosed supplementary cementitious materials, produced from waste materials, significantly increases the sustainability of concrete, grouts, and other cementitious materials and the built environment.

Most supplementary cementitious materials are byproducts of materials being thermally processed. For example, slag is a byproduct of the iron/steel production process, while fly ash or bottom ash is a byproduct of coal combustion in coal-fired power generation plants. In the case of natural pozzolans (NPs), these materials have been thermally processed through the natural heat of the earth's crust. A primary mining process is used in which volcanic materials are excavated and milled to a fine, pozzolanically reactive state. Natural pozzolans may also be thermally treated using a calcination or sintering process (not using natural heat of the earth's crust) to enhance pozzolanic reactivity. Pozzolans may also be created by means of mechanical activation of mine waste or manufactured waste as well as of naturally deposited siliceous materials.

The invention has been tested at the laboratory scale—the results of which indicate that certain mine waste materials processed at precise temperatures and retention times, and in specific compositions, result in a surprisingly effective SCM which will meet the applicable industry standards such as ASTM, AASHTO, and related international standards. Some processed mine waste materials are effective supplementary cementitious materials although they may not meet current, applicable industry standards.

Having proven the ability to convert and repurpose mine waste into a valuable SCM, this new product will not only mitigate the environmental challenges related to mine waste but will add significantly to the sustainability of the concrete and cementitious-built environment and meaningfully and significantly reduce the carbon footprint of cements and concrete.

In various embodiments, there are three types of mined waste or gangue materials which are targeted for remediation, conversion, and repurposing into valuable supplementary cementitious materials (SCMs) for further use in cements, concretes, mortar, grout, and other cementitious materials based products.

1. Overburden. Overburden is a mined waste product, which is removed from the upper zone overlaying the primary target metals or minerals located within the deposit. The overburden can consist of sedimentary, metamorphic, or igneous materials or a combination of any of these materials. Overburden is generally stored or sequestered on-site, requiring considerable site or land space.

2. Primary ore processing waste. Primary ore has been processed to remove the targeted metals or minerals, e.g., borax, gold, copper, aluminum, iron, sand, etc. This material is often referred to as gangue or waste material from the primary process and is usually stored on site requiring considerable site space.

3. Reprocessed waste materials. Reprocessed waste materials such as reprocessed gangue may have residual, extractable secondary metals or minerals, such as lithium or borax. Reprocessed waste materials have been processed at least two times, prior to being processed, converted, and/or remediated according to the present invention.

Some variations provide a process for producing a supplementary cementitious material from a mine waste material, the process comprising:
(a) obtaining a mine waste material containing a pozzolanic component, a pre-pozzolanic component, or a combination thereof;
(b) crushing the mine waste material to reduce the particle size, thereby generating a crushed mine waste material with an average particle size selected from about 0.1 millimeters to about 50 millimeters;
(c) optionally, calcining or sintering the crushed mine waste material at a first calcining or sintering temperature selected from about 600° C. to about 1600° C. and a first calcining or sintering time selected from about 1 second to about 10 hours;
(d) milling the crushed mine waste material or a calcined or sintered form thereof, to further reduce particle size, thereby generating a milled mine waste material with a median particle size (D50) selected from about 1 micron to about 50 microns;
(e) optionally, calcining or sintering the milled mine waste material at a second calcining or sintering temperature selected from about 600° C. to about 1600° C. and a second calcining or sintering time selected from about 1 second to about 10 hours;
(f) optionally, introducing a separate pozzolan to the mine waste material, the crushed mine waste material or a calcined/sintered form thereof, the milled mine waste material or a calcined/sintered form thereof, or a combination thereof; and
(g) recovering the milled mine waste material or a calcined/sintered form thereof as a supplementary cementitious material, wherein the supplementary cementitious material contains the separate pozzolan if step (f) is conducted.

In this specification, a “pozzolanic component” means a component that is a finely divided siliceous or siliceous and aluminous material that reacts chemically with calcium hydroxide, Ca(OH)₂ , in the presence of moisture to form a slow-hardening cement. A “pre-pozzolanic” component means a component that is capable of becoming pozzolanic, when the component is crushed, milled, and optionally calcined or sintered.

A pozzolanic component may provide protection to concrete by mitigating various forms of chemical attack such as alkali-silica reactions, sulfate-induced expansion, or efflorescence. A pozzolanic component may provide densify concrete, reducing porosity and permeability, thereby reducing chemical ingress and increasing long-term compressive strength and durability.

In some embodiments, the mine waste material is obtained from mining of borax, lithium, gold, silver, platinum, palladium, rhodium, molybdenum, copper, nickel, aluminum, iron, zinc, phosphorous, silica, sand, clay, slate, shale, and combinations thereof.

The mine waste material (e.g., gangue or overburden), as typically stored on the mine site, may have a wide variety of particle sizes, such as anywhere from less than 45 microns to about 30 centimeters or more in diameter. During crushing, the large particles are reduced in particle size, while particles that are already small (e.g., 100 microns) may pass through the crushing step without significant particle-size reduction.

In some embodiments, in step (b), the average particle size of the crushed mine waste material is selected from about 0.5 millimeters to about 25 millimeters. In certain embodiments, the average particle size is selected from about 1 millimeter to about 10 millimeters. In various embodiments, the average particle size of the crushed mine waste material is about, at least about, or at most about 0.1, 0.2, 0.3, 0.4, 0.5, 0.6, 0.7, 0.8, 0.9, 1, 1.5, 2, 2.5, 3, 4, 5, 6, 7, 8, 9, 10, 11, 12, 13, 14, 15, 20, 25, 30, 35, 40, 45, or 50 millimeters, including any intervening range.

In some embodiments, the mine waste material is a waste overburden material. In some embodiments, the mine waste material is a waste gangue material. In some embodiments, the mine waste material is a reprocessed waste material. In some embodiments, the mine waste material is a blend of at least two of a waste overburden material, a waste gangue material, and a reprocessed waste material. In certain embodiments, the mine waste material is a blend of a waste overburden material, a waste gangue material, and a reprocessed waste material.

Combinations are also possible at different points in the process. For example, a combined waste overburden and waste gangue may be combined and processed, starting with step (b). In other embodiments, waste overburden and waste gangue are separately processed into milled (and optionally calcined/sintered) mine waste materials, and then combined.

In certain embodiments, only a portion of a mine waste material is crushed, milled, and calcined/sintered prior to blending into a final product (supplementary cementitious material), while another portion of mine waste material is crushed and milled, but not calcined or sintered, before final mixing.

In certain embodiments employing calcining or sintering, an initial crush (or shredding) of the feedstock ensures that everything that goes into the calciner or sintering device is about ¼″ (about 6.4 mm) or smaller. This is done for good heat transfer, ensuring that the calcining or sintering temperature reaches all of the material.

Particles larger than ¼″ leave open the possibility that material inside the aggregate is not fully calcined or sintered. Nevertheless, larger particles (including up to about 50 mm) may be calcined or sintered, depending on the porosity, the nature of the specific materials, any agitation during calcination/sintering, or other factors.

In some embodiments, crushing is followed by calcining or sintering (which may be referred to as “calcining/sintering”), which is followed by milling.

However, other process sequences are possible, including the option to integrate steps to be performed simultaneously. For example, step (b) may be integrated with step (c), such that calcining/sintering and crushing are simultaneous. Step (c) may be integrated with step (d), such that calcining/sintering and milling are simultaneous.

Generally speaking, calcining or sintering is optional. When calcining or sintering is performed, the order of calcining/sintering and milling may be reversed. In some embodiments, neither steps (c) nor (e) are performed. In some embodiments, step (c) but not step (e) is performed. In some embodiments, step (e) but not step (c) is performed. In some embodiments, both steps (c) and (e) are performed.

In some embodiments in which step (c) is conducted, the first calcining or sintering temperature may be selected from about 700° C. to about 1200° C. In certain embodiments, the first calcining or sintering temperature is selected from about 750° C. to about 1000° C. In various embodiments, the first calcining or sintering temperature is about, at least about, or at most about 600° C., 650° C., 700° C., 750° C., 800° C., 850° C., 900° C., 950° C., 1000° C., 1050° C., 1100° C., 1150° C., 1200° C., 1250° C., 1300° C., 1350° C., 1400° C., 1450° C., 1500° C., 1550° C., or 1600° C., including any intervening range.

In some embodiments in which step (c) is conducted, the first calcining or sintering time may be selected from about 2 seconds to about 5 hours. In certain embodiments, the first calcining or sintering time is selected from about 0.5 hours to about 2 hours. In various embodiments, the first calcining or sintering time is about, at least about, or at most about 1, 2, 5, 10, 20, 30, 40, 50, 60 seconds; 1, 2, 5, 10, 20, 30, 40, 50, or 60 minutes; or 1, 1.1, 1.2, 1.3, 1.4, 1.5, 1.6, 1.7, 1.8, 1.9, 2, 2.5, 3, 3.5, 4, 4.5, 5, 6, 7, 8, 9, or 10 hours, including any intervening range.

In some embodiments in which step (e) is conducted, the second calcining or sintering temperature may be selected from about 700° C. to about 1200° C. In certain embodiments, the second calcining or sintering temperature is selected from about 750° C. to about 1000° C. In various embodiments, the second calcining or sintering temperature is about, at least about, or at most about 600° C., 650° C., 700° C., 750° C., 800° C., 850° C., 900° C., 950° C., 1000° C., 1050° C., 1100° C., 1150° C., 1200° C., 1250° C., 1300° C., 1350° C., 1400° C., 1450° C., 1500° C., 1550° C., or 1600° C., including any intervening range.

In some embodiments in which step (e) is conducted, the second calcining or sintering time may be selected from about 0.2 hours to about 5 hours. In certain embodiments, the second calcining or sintering time is selected from about 0.5 hours to about 2 hours. In various embodiments, the second calcining or sintering time is about, at least about, or at most about 1, 2, 5, 10, 20, 30, 40, 50, 60 seconds; 1, 2, 5, 10, 20, 30, 40, 50, or 60 minutes; or 1, 1.1, 1.2, 1.3, 1.4, 1.5, 1.6, 1.7, 1.8, 1.9, 2, 2.5, 3, 3.5, 4, 4.5, 5, 6, 7, 8, 9, or 10 hours, including any intervening range.

Note that reference to “first” and “second” conditions for the calcining/sintering in steps (c) and (e) does not necessarily mean there are two calcining/sintering steps. These adjectives are used for purposes of clarity and antecedent basis. If step (c) is omitted while step (e) is performed, and no other calcining/sintering is conducted other than in step (e), it will be understood that “second calcining or sintering temperature” and “second calcining or sintering time” can also be referred to as “the calcining or sintering temperature” and “the calcining or sintering time”.

In certain embodiments, the process conditions of calcining or sintering are selected to replicate naturally occurring processes. For example, some embodiments calcine or sinter igneous and sedimentary materials to replicate the natural subduction (magma-producing) zones created by plate tectonics, which are the source of most raw natural pozzolans. In such embodiments, the process recreates the conditions by which pozzolans are naturally created, by way of thermal processing, which converts crystalline silicious, aluminous, and ferrous rocks into a non-crystalline amorphous phase. These amorphous materials, after being ejected from the process (e.g., from a kiln), kinetically freeze in their non-crystalline phase—and like volcanic ejecta, are pozzolanic in nature once they have been milled to the proper size.

In some embodiments, in step (d), the median particle size (D50) of the milled mine waste material is selected from about 2 microns to about 25 microns. In certain embodiments, the median particle size (D50) is selected from about 10 microns to about 20 microns. In certain embodiments, the median particle size (D50) is selected from about 1 micron to about 10 microns. In various embodiments, the median particle size (D50) of the milled mine waste material is about, at least about, or at most about 1, 2, 3, 4, 5, 6, 7, 8, 9, 10, 11, 12, 13, 14, 15, 16, 17, 18, 19, 20, 21, 22, 23, 24, 25, 30, 35, 40, 45, or 50 microns (μm), including any intervening range. If step (c) is performed, then the milled mine waste material is a calcined/sintered milled mine waste material, and the calcined/sintered milled mine waste material may have the median particle size range specified in this paragraph.

In addition to the D50 value, particle-size distribution of the milled mine waste material may be important. Particle-size distribution has a strong correlation to water demand of the product in concrete/mortar. Thus, generally speaking, the particle-size distribution is preferably fine enough to impart a water demand that is acceptable to end users. Whereas most natural pozzolans are quite porous, grinding them down will eliminate much of that porosity and thus decrease water demand. In some embodiments, a preferred D50 range is 10-20 μm for the milled mine waste material, as well as for uncalcined volcanic natural pozzolans, or other pozzolans, that are optionally blended into the composition. In some embodiments, a preferred D50 range is 1-10 μm for the milled mine waste material, as well as for uncalcined volcanic natural pozzolans, or other pozzolans, that are optionally blended into the composition.

In some embodiments, in step (d), milling mechanically activates the crushed mine waste material to increase pozzolanicity. “Mechanical activation”, “mechanically activating”, and the like refer to particle-size reduction and heating (e.g., caused by particle friction) that alters the crystalline structure and renders the mine waste material partially amorphous and pozzolanic, even without calcination or sintering.

In some embodiments in which step (c) is performed, calcining or sintering thermally activates the crushed mine waste material to increase pozzolanicity. “Thermal activation”, “thermally activating”, and the like refer to heating during calcining/sintering that alters the crystalline structure and renders the mine waste material partially amorphous and pozzolanic.

In some embodiments in which step (e) is performed, calcining or sintering thermally activates the milled mine waste material to increase pozzolanicity. In these embodiments, heating during calcining/sintering alters the crystalline structure and renders the mine waste material more amorphous and more pozzolanic.

In some embodiments, step (e) is performed, and it may be preferred to mill the calcined/sintered material again, such as if particle agglomeration occurred during calcination or sintering. Thus, the process may further comprise additional milling of a calcined or sintered form of the milled mine waste material, thereby generating a milled calcined/sintered mine waste material with a median particle size (D50) selected from about 1 micron to about 50 microns.

In some embodiments, step (f) is performed, and the separate pozzolan is selected from the group consisting of natural pozzolans, coal fly ash, coal bottom ash, silica fume, ground granulated blast-furnace slag, diatomaceous earth (DE), zeolites, metakaolin, and combinations thereof, for example.

In some embodiments, step (f) is performed, and the separate pozzolan meets a pozzolan specification under ASTM, ACI, and/or AASHTO. In other embodiments, the separate pozzolan is a non-spec pozzolan that does not meet a pozzolan specification under ASTM, ACI, or AASHTO.

When step (f) is performed, the separate pozzolan may be introduced by blending or intergrinding, for example. Here, blending refers to simple mixing, while intergrinding refers to mixing in conjunction with mechanical action that reduces particle size of the total material.

When step (f) is performed, the separate pozzolan may be introduced at many different points in the process, or at multiple points. In some embodiments, the separate pozzolan is introduced to the mine waste material prior to step (b), or during step (b). In some embodiments, the separate pozzolan is introduced to the crushed mine waste material between step (b) and step (c), or during step (c). In some embodiments, the separate pozzolan is introduced to the milled mine waste material during step (d), or between step (d) and step (e). In some embodiments, the separate pozzolan is introduced to the milled mine waste material during step (e).

In some embodiments, the supplementary cementitious material recovered in step (g) is blended or interground with uncalcined waste overburden material, uncalcined waste gangue material, uncalcined reprocessed waste material, or an uncalcined combination thereof. Here, blending refers to simple mixing of supplementary cementitious material with the uncalcined waste gangue material and/or uncalcined reprocessed waste material, while intergrinding refers to mixing in conjunction with mechanical action that reduces particle size of the final mixed material.

In preferred processes, the supplementary cementitious material, recovered in step (g), has a 7-day strength activity index SAI of at least 75%, to meet the ASTM C618 standard. In some embodiments, the 7-day strength activity index SAI is at least 80%, such as at least 81%, 82%, 83%, 84%, 85%, 86%, 87%, 88%, 89%, 90%, including any intervening range.

In preferred processes, the supplementary cementitious material has a 28-day strength activity index SAI of at least 75%, to meet the ASTM C618 standard. In some embodiments, the 28-day strength activity index SAI is at least 80%, at least 85%, or at least 90%, such as at least 81%, 82%, 83%, 84%, 85%, 86%, 87%, 88%, 89%, 90%, 91%, 92%, 93%, 94%, 95%, 96%, 97%, 98%, 99%, 100%, or exceeding 100%, including any intervening range.

In preferred processes, the supplementary cementitious material is a pozzolan pursuant to ASTM (e.g., ASTM C618), ACI (e.g., ACI PRC-232.1-12), and/or AASHTO (e.g., AASHTO M295), which are hereby incorporated by reference.

In some embodiments, the supplementary cementitious material contains borax. In some embodiments, the supplementary cementitious material contains lithium.

In certain embodiments, the supplementary cementitious material contains lithium and borax.

In various embodiments, the supplementary cementitious material contains gold, silver, platinum, palladium, rhodium, molybdenum, copper, nickel, aluminum, iron, zinc, phosphorous, silica, sand, clay, slate, shale, or a combination thereof.

Known crushing, calcining/sintering, and milling apparatus may be utilized for the process. When calcining or sintering is performed, it is possible to combine the calcining/sintering step with the crushing step, in an integrated crusher-calciner or sintering device. It is also possible to combine the calcining or sintering step with the milling step, in an integrated milling-calcining unit or sintering device.

The process may be carried out as a continuous process, a semi-continuous process, or a batch process.

Some variations of the invention provide a system for producing a supplementary cementitious material from a mine waste material, the system comprising:
a system inlet for receiving a mine waste material containing a pozzolanic component, a pre-pozzolanic component, or a combination thereof;
a crushing unit configured to crush the mine waste material to reduce the particle size, thereby generating a crushed mine waste material with an average particle size selected from about 0.1 millimeters to about 50 millimeters;
optionally, a first calciner or sintering furnace configured for calcining or sintering the crushed mine waste material at a first calcining or sintering temperature selected from about 600° C. to about 1600° C. and a first calcining or sintering time selected from about 1 second to about 10 hours;
a milling unit configured for milling the crushed mine waste material or a calcined form thereof, to further reduce particle size, thereby generating a milled mine waste material with a median particle size (D50) selected from about 1 micron to about 50 microns;
optionally, a second calciner or sintering furnace configured for calcining or sintering the milled mine waste material at a second calcining or sintering temperature selected from about 600° C. to about 1600° C. and a second calcining or sintering time selected from about 1 second to about 10 hours;
optionally, a mixer or grinder configured for introducing a separate pozzolan to the mine waste material, the crushed mine waste material or a calcined/sintered form thereof, the milled mine waste material or a calcined/sintered form thereof, or a combination thereof; and
a system outlet for recovering the milled mine waste material or a calcined/sintered form thereof as a supplementary cementitious material.

Some variations of the invention provide a supplementary cementitious material produced by any of the disclosed processes or systems. The supplementary cementitious material may be analyzed via known analytical techniques to show that a disclosed process was used to make the product.

Preferably, the supplementary cementitious material has a 7-day strength activity index SAI of at least 75%, to meet the ASTM C618 standard. In some embodiments, the 7-day strength activity index SAI is at least 80%, such as at least 81%, 82%, 83%, 84%, 85%, 86%, 87%, 88%, 89%, 90%, including any intervening range.

Preferably, the supplementary cementitious material has a 28-day strength activity index SAI of at least 75%, to meet the ASTM C618 standard. In some embodiments, the 28-day strength activity index SAI is at least 80%, at least 85%, or at least 90%, such as at least 81%, 82%, 83%, 84%, 85%, 86%, 87%, 88%, 89%, 90%, 91%, 92%, 93%, 94%, 95%, 96%, 97%, 98%, 99%, 100%, or exceeding 100%, including any intervening range.

In certain embodiments, the supplementary cementitious material contains borax. In these or other embodiments, the supplementary cementitious material may contain lithium. Borax and lithium may confer certain beneficial properties to the supplementary cementitious material. For example, lithium may help mitigate concrete chemical attack, particularly Alkali-Silica Reactions (ASR), and may also slightly reduce water demand in a concrete mix design. Borax may extend the cement set time by around 30-60 minutes, allowing for a longer period of workability than a straight cement mix. This extra 30-60 minutes of workability is very similar to the extra working time provided by the use of fly ash in concrete or mortar. Without being limited by theory, this useful phenomenon is related to borax's effect on cement to decrease the initial heat of hydration and enhance the fluidity of the mortar/concrete mix. This increase in fluidity allows for a lower water-to-cementitious ratio which further enhances the concrete or mortar.

Generally speaking, calcined or sintered clays have higher water demand than the typical volcanic tephra-derived raw pozzolans. Thus, the clay gangue would normally have a higher water demand than such pozzolans. However, in some embodiments, the residual borax and/or lithium in the gangue lowers the water demand, as does the shale component of the gangue. Calcined or sintered gangue pozzolan surprisingly provides a lower water demand compared to most other natural pozzolans.

In certain embodiments, the supplementary cementitious material contains gold, silver, platinum, palladium, rhodium, molybdenum, copper, nickel, aluminum, iron, zinc, phosphorous, silica, sand, clay, slate, shale, or a combination thereof.

In some preferred embodiments, the supplementary cementitious material is a pozzolan pursuant to ASTM and/or AASHTO. In other embodiments, the supplementary cementitious material is not classified as an “in-spec” pozzolan pursuant to ASTM and/or AASHTO, i.e. does not meet the specification as such, but does meet the definition of a “pozzolan” per ASTM C125 (e.g., ASTM C125-21a).

In some embodiments, the resulting supplementary cementitious material is utilized as a remediation agent to remediate non-spec fly ash, such as to convert non-spec fly ash into a Class C fly ash or a Class F fly ash, or to convert a Class C fly ash into a Class F fly ash, for example. The supplementary cementitious material may be used to upgrade a non-spec natural pozzolan or a poorly compliant natural pozzolan to a higher grade or spec natural pozzolan.

The supplementary cementitious material may be used in concrete, mortar or grout applications intended to supplement, replace, or enhance cement, such as portland cement, blended cements, ASTM C1157 cements. The supplementary cementitious material may be blended with fly ash, bottom ash, slag, or any other cementitious material, for various applications.

All publications, patents, and patent applications cited in this specification are incorporated herein by reference in their entirety as if each publication, patent, or patent application was specifically and individually put forth herein. Also, all relevant specifications and standards of ASTM, ACI, and AASHTO are incorporated herein by reference in their entirety, including at least those specifications and standards explicitly referenced.

In this detailed description, reference has been made to multiple embodiments of the disclosure and non-limiting examples relating to how the disclosure can be understood and practiced. Other embodiments that do not provide all of the features and advantages set forth herein may be utilized, without departing from the spirit and scope of the present disclosure. This disclosure incorporates routine experimentation and optimization of the methods and systems described herein. Such modifications and variations are considered to be within the scope of the invention defined by the claims.

Where methods and steps described above indicate certain events occurring in certain order, those of ordinary skill in the art will recognize that the ordering of certain steps may be modified and that such modifications are in accordance with the variations of the disclosure. Additionally, certain of the steps may be performed concurrently in a parallel process when possible, as well as performed sequentially.

Therefore, to the extent that there are variations of the disclosure, which are within the spirit of the disclosure or equivalents of the appended claims, it is the intent that this patent will cover those variations as well. The present disclosure shall only be limited by what is claimed.

### EXAMPLES

### Example A: Supplementary Cementitious Materials from Remediated Mine Waste.

The mine waste in this example comes from one of North America's largest open-pit mines. There are now hundreds of millions of tons of waste material stored onsite, taking up substantial land area and inhibiting the efficiency of mining operations. The waste materials are derived from either (1) material processing—extraction of specific minerals from the ore body—which results in a large volume of byproduct waste, or (2) the excavation and onsite storage of overburden layers of sandstone and volcanic ash. The overburden materials overlay targeted shale and clay formations which hold the desired minerals/metals. These ore body shales and clays are then crushed and treated in order to remove the desired high-value materials, in existing operations. This example demonstrates technology to convert the massive volumes of waste into useful products.

In particular, in this Example A, the mine waste materials have been beneficiated to achieve both minimal and desirable levels of performance as a supplementary cementitious material (SCM), specifically meeting the specifications of ASTM C618 and AASHTO M295 for Class N Natural Pozzolans. ASTM C618 and AASHTO M295 are Class N natural pozzolan compliance certifications.

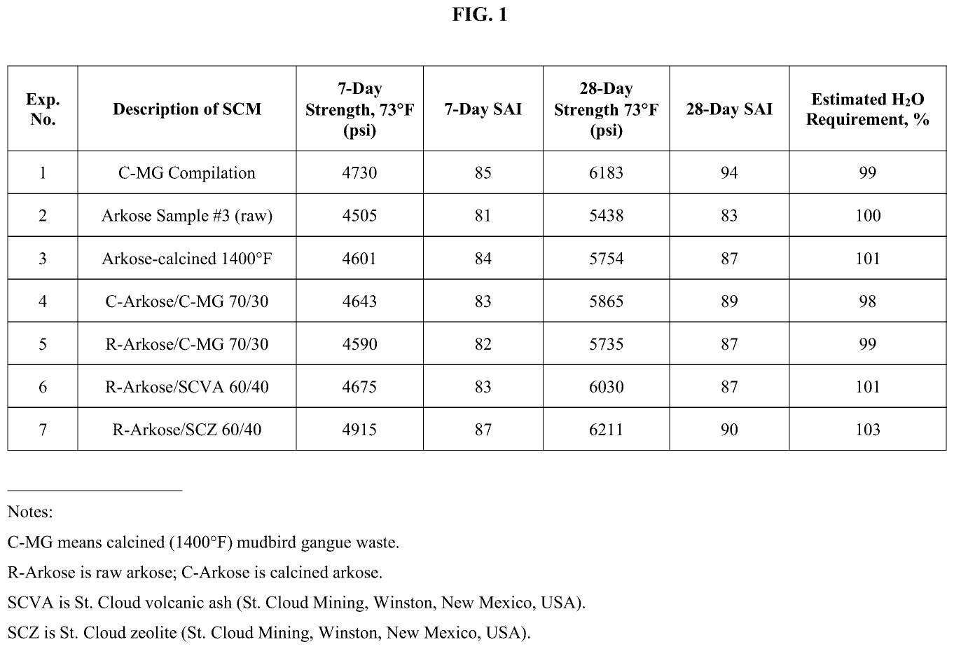

FIG. 1 shows a table of data for representative experiments 1 to 7, discussed in more detail below. In FIG. 1, all mixes are at a water/cementitious weight ratio=0.484 with no water reducer or other admixtures. Under C618/C311 guidelines, to test the viability of the pozzolan, one replaces 20% of the cement with the pozzolan, i.e.

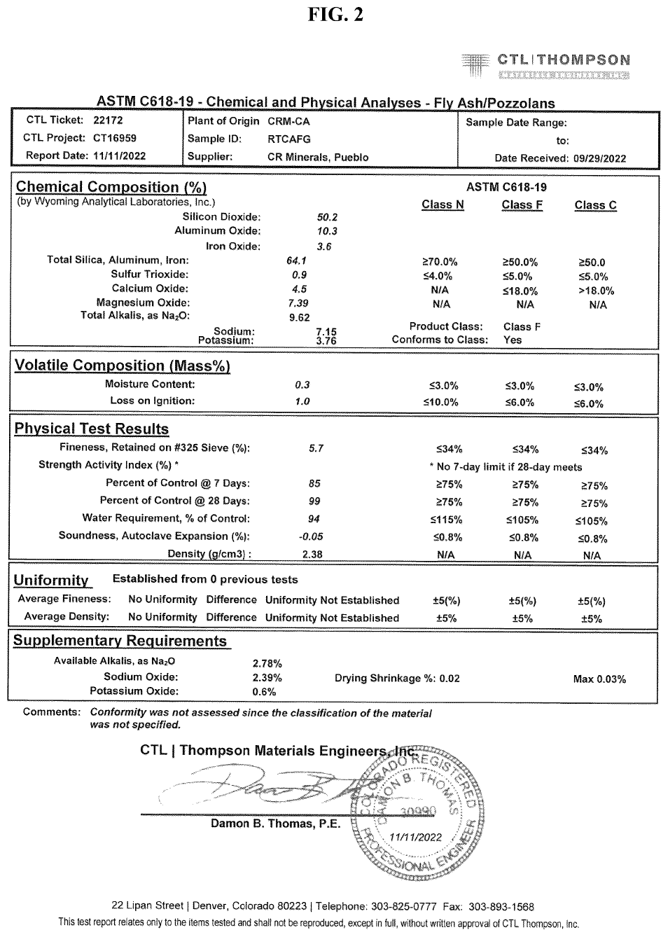

the cement/SCM ratio is 80/20. Compression testing is performed to measure the strength activity index (SAI). The SAI is preferably at least 75% at both 7 days and 28 days. The weight ratios within a particular SCM are on a weight basis; e.g. C-Ark/C-MG 70/30 indicates 70 wt % calcined arkose and 30 wt % calcined mudbird gangue, for that SCM. FIG. 2 shows an ASTM C618-19 compliance certificate for the calcined mudbird gangue, showing that it meets the specification for a ASTM C618 class N pozzolan.

As illustrated in FIG. 1, Experiment No. 1, the C-MG (mudbird gangue calcined at 1400° F.), a compilation sample of processed mine waste, exhibits excellent SAI results. The results indicate that this natural pozzolan is a very desirable supplementary cementitious material (SCM) in the cement and concrete industries.

Arkose is a form of sandstone. Experiment No. 2 tested raw, uncalcined arkose. Experiment No. 3 tested arkose that had been calcined at 1400° F. (760° C.). The calcined results led to a slightly higher SAI at both 7 and 28 days. The raw arkose and calcined arkose exhibit very good reactivity levels as indicated by their respective SAIs, as well as excellent water demand. The calcined arkose was analyzed and determined to comply with the standard physical and composition requirements for Class N natural pozzolans as specified by ASTM C618.

Experiment No. 4 tested calcined arkose combined with calcined mudbird gangue. Experiment No. 5 tested uncalcined arkose combined with calcined mudbird gangue. Both experiments were successful. When calcined mudbird gangue is blended with calcined or uncalcined arkose, the result is a very good blended pozzolan which can be used in a wide variety of cement/concrete applications.

For Experiment No. 4, the SCM made from the 70/30 blend of calcined arkose and calcined mudbird gangue was measured to have 68.7 wt % SiO₂, 14.8 wt % Al₂O₃, and 3.1 wt % Fe₂O₃ (total 86.6 wt %, exceeding the 70.0 wt % minimum). The available alkalis as Na₂ O eq (%) was measured as 1.0, below the maximum of 1.5. For Experiment No. 5, the SCM made from the 70/30 blend of raw arkose and calcined mudbird gangue was measured to have 59.8 wt % SiO₂, 12.8 wt % Al₂O₃ , and 3.2 wt % Fe₂O₃ (total 75.9 wt %, exceeding the 70.0 wt % minimum).

Experiment No. 6 tested a composite overburden consisting of sandstone (arkose) and volcanic ash. Experiment No. 7 tested a composite overburden consisting of sandstone (arkose) and zeolite. These two experiments were also successful. When uncalcined (raw) arkose is blended with off-site natural pozzolans such as volcanic ash or zeolite, the reactivity (SAI) results are excellent.

ASTM C1567 measures a pozzolan's performance as it relates to mitigation of alkali-silica reactions caused by reactive aggregates. ASTM C1567 testing was performed, showing acceptable 14-day expansion (about 0.01%) under ASTM C1567, for a SCM that combines uncalcined arkose with volcanic ash (Experiment No. 6). Another test of a SCM with 50 wt % uncalcined arkose and 50 wt % volcanic ash also showed an acceptable 14-day expansion (about 0.01%) under ASTM C1567.

The results in FIG. 1, the ASTM C618 compliance results, and the ASTM C1567 performance results indicate that the calcined and uncalcined overburden arkose-volcanic ash mix meet all ASTM C618 requirements as a Class N pozzolan.

In other experiments, uncalcined arkose was blended with various natural pozzolans (volcanic ashes, zeolites, rhyolites, diatomaceous earth, and CR Minerals remediated fly ash) and coal combustion products such as fly ash and bottom ash, which enhanced the performance of the remediated waste materials. The results indicate that remediated mine wastes, individually or blended, and/or blended with off-site natural pozzolans and/or coal combustion residuals (fly ash, bottom ash, or both), meet the compliance requirements for use in concrete, mortar, pre-cast, ASTM C595 blended cements, and other cementitious products such as alkali-activated cement and geopolymers.

The data in this Example A indicates that mine waste products can be significantly remediated and converted to highly valuable SCMs for the cement and concrete industries, while also drastically reducing the carbon footprint of the replaced cementitious materials in concrete-related products. All of the tested samples met or exceeded the applicable ASTM and AASHTO standards for use in cement and concrete, and will reduce the carbon footprint of portland cement by up to 70%, 80%, 90%, or more, on a pound-for-pound basis, depending on the products and combinations used.

### Example B: Supplementary Cementitious Materials from Remediated Mine Waste.

The mine waste in this example is a processed analcime and/or spodumene from which certain lithium has been extracted, leaving behind a byproduct waste material which must either be landfilled or legally stored in waste piles near the production facility. The analcime ore is crushed and treated in order to remove the desired high-value materials. This example demonstrates technology to convert the piles of waste into useful products.

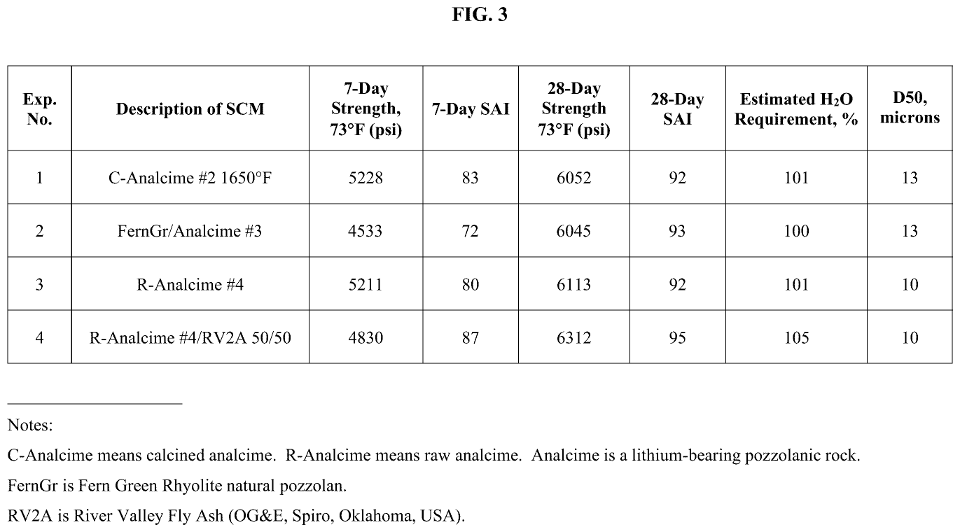

FIG. 3 shows a table of data for representative experiments 1 to 4, discussed in more detail below. In FIG. 3, all mixes are at a water/solids weight ratio=0.484 with no water reducer or other admixtures. Under C618/C311 guidelines, to test the viability of the pozzolan, one replaces 20% of the cement with the pozzolan, i.e. the cement/SCM ratio is 80/20. Compression testing is performed to measure the strength activity index (SAI). The SAI is preferably at least 75% at both 7 days and 28 days. The weight ratios within a particular SCM are on a weight basis; e.g. R-Analcime #4/RV2A 50/50 indicates 50 wt % raw analcime and 50 wt % fly ash, for that SCM.

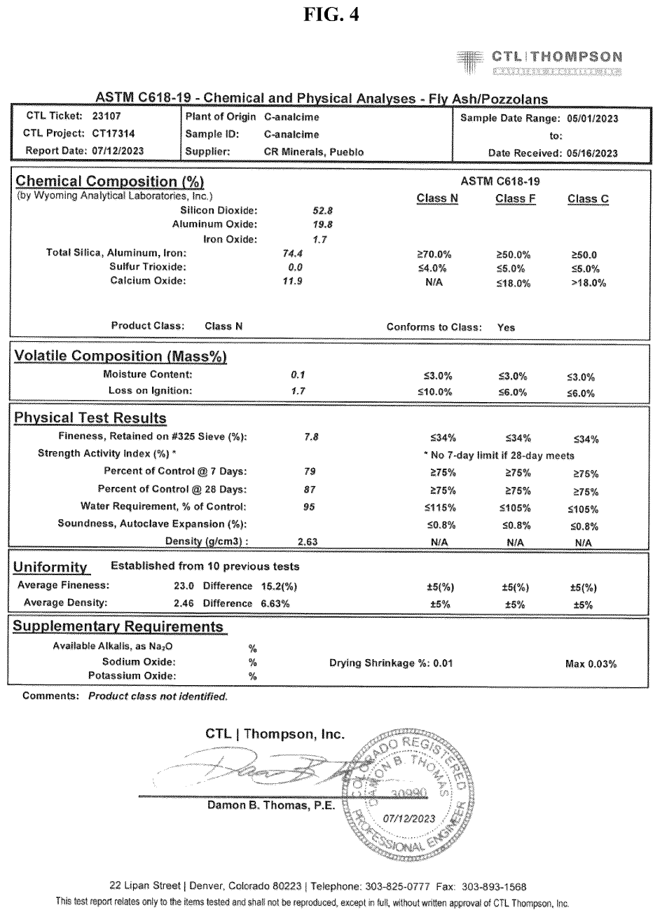

FIG. 4 shows an ASTM C618-19 compliance certificate for the calcined and milled (D50=13 μm) analcime, showing that it meets the specification for a ASTM C618 class N pozzolan.

In this example, the mine waste material has been beneficiated to achieve both minimal and desirable levels of performance as a supplementary cementitious material (SCM), specifically meeting the specifications of ASTM C618 and AASHTO M295 for Class N natural pozzolans.

ASTM C1567 measures a pozzolan's performance as it relates to mitigation of alkali-silica reactions caused by reactive aggregates. ASTM C1567 testing was performed, showing acceptable 14-day expansion (about 0.05%) under ASTM C1567, for a SCM made from crushed and milled uncalcined analcime (Experiment No. 3 in FIG. 3). This is a noteworthy result that clearly indicates the processed analcime mine waste mitigates alkali-silica reaction (ASR). It is expected that the calcined analcime would also mitigate ASR, even more effectively than does the uncalcined analcime.

FIG. 3, FIG. 4, and the ASTM C1567 performance results clearly indicate that the calcined and uncalcined analcime meets ASTM C618 requirements. Of particular note, the Analcime #2 sample, calcined at 1650° F. (Experiment No. 1), achieved exceptional compression strength as well as exceptional SAI at 7 days (SAI=83) and 28 days (SAI=92), with a water demand of 101%, making this a very desirable pozzolan for the cement and concrete industries. The uncalcined Analcime sample #3, when blended with a known ASTM C618-compliant natural pozzolan, Fern Green Rhyolite natural pozzolan, also achieved excellent SAI=93 at 28 days. The uncalcined Analcime sample #4, milled down to a median particle size (MPS) of 10 microns (D50), showed surprisingly high SAI without the benefit of calcination. Lastly, the uncalcined

Analcime #4, when blended with a fly ash (River Valley, Okla.), demonstrated surprising compression strength and SAI at both 7 days and 28 days, and would easily meet all appropriate industry standards for natural pozzolans, such as ASTM C618.

In other experiments in this Example B, the remediated mine waste material (processed analcime and/or spodumene) was blended with off-site natural pozzolans such as volcanic ashes, rhyolites, other natural pozzolans, and coal combustion products such as fly ash and bottom ash, enhancing the performance of the remediated waste materials and meeting the requirements of C618 Class N and AASHTO M295. The remediated mine waste, individually or blended with off-site natural pozzolans and/or coal combustion residuals (fly ash and/or bottom ash), meet the required compliance for use in all concrete, mortar, pre-cast, ASTM C595 blended cements, and other cementitious products such as alkali-activated cement and geopolymers.

All of the tested materials from this mine waste site met applicable ASTM and AASHTO standards for SCMs used in cement and concrete. The materials lowered the carbon footprint of the concrete by up to 90%, or more, on a pound-for-pound basis, depending on the products and combinations used.

As will be appreciated by one skilled in the art, different variations of the tested blends would be effective non-spec SCMs which can be used in applications not requiring an ASTM or AASTO specification.

What is claimed is:

1. A process for producing a supplementary cementitious material from a mine waste material, said process comprising:
(a) obtaining a mine waste material containing a pozzolanic component, a pre-pozzolanic component, or a combination thereof;
(b) crushing said mine waste material to reduce the particle size, thereby generating a crushed mine waste material with an average particle size selected from about 0.1 millimeters to about 50 millimeters;
(c) optionally, calcining or sintering said crushed mine waste material at a first calcining or sintering temperature selected from about 600° C. to about 1600° C. and a first calcining or sintering time selected from about 1 second to about 10 hours;
(d) milling said crushed mine waste material or a calcined or sintered form thereof, to further reduce particle size, thereby generating a milled mine waste material with a median particle size (D50) selected from about 1 micron to about 50 microns;
(e) optionally, calcining or sintering said milled mine waste material at a second calcining or sintering temperature selected from about 600° C. to about 1600° C. and a second calcining or sintering time selected from about 1 second to about 10 hours;
(f) optionally, introducing a separate pozzolan to said mine waste material, said crushed mine waste material or a calcined or sintered form thereof, said milled mine waste material or a calcined or sintered form thereof, or a combination thereof; and
(g) recovering said milled mine waste material or a calcined or sintered form thereof as a supplementary cementitious material, wherein said supplementary cementitious material contains said separate pozzolan if step (f) is conducted.

2. The process of claim 1, wherein said mine waste material is a waste overburden material.

3. The process of claim 1, wherein said mine waste material is a waste gangue material.

4. The process of claim 1, wherein said mine waste material is a reprocessed waste material.

5. The process of claim 1, wherein said mine waste material is a blend of at least two of a waste overburden material, a waste gangue material, and a reprocessed waste material.

6. The process of claim 1, wherein said mine waste material is a blend of a waste overburden material, a waste gangue material, and a reprocessed waste material.

7. The process of claim 1, wherein said supplementary cementitious material recovered in step (g) is blended or interground with uncalcined waste overburden material, uncalcined waste gangue material, uncalcined reprocessed waste material, or an uncalcined combination thereof.

8. The process of claim 1, wherein said mine waste material is obtained from mining of borax, lithium, gold, silver, platinum, palladium, rhodium, molybdenum, copper, nickel, aluminum, iron, zinc, phosphorous, silica, sand, clay, slate, shale, and combinations thereof.

9. The process of claim 1, wherein in step (d), said milling mechanically activates said crushed mine waste material to increase pozzolanicity.

10. The process of claim 1, wherein step (c) is performed, and wherein said calcining or sintering thermally activates said crushed mine waste material to increase pozzolanicity.

11. The process of claim 1, wherein step (e) is performed, and wherein said calcining or sintering thermally activates said milled mine waste material to increase pozzolanicity.

12. The process of claim 1, wherein step (e) is performed, and wherein said process further comprises milling a calcined or sintered form of said milled mine waste material, thereby generating a milled calcined/sintered mine waste material with a median particle size (D50) selected from about 1 micron to about 50 microns.

13. The process of claim 1, wherein step (f) is performed, and wherein said separate pozzolan is selected from the group consisting of natural pozzolans, coal fly ash, coal bottom ash, silica fume, ground granulated blast-furnace slag, diatomaceous earth, zeolites, metakaolin, and combinations thereof.

14. The process of claim 1, wherein step (f) is performed, and wherein said separate pozzolan meets a pozzolan specification under ASTM, ACI, and/or AASHTO.

15. The process of claim 1, wherein step (f) is performed, and wherein said separate pozzolan is a non-spec pozzolan that does not meet a pozzolan specification under ASTM, ACI, or AASHTO.

16. The process of claim 1, wherein in step (b), said average particle size is selected from about 0.5 millimeters to about 25 millimeters.

17. The process of claim 16, wherein said average particle size is selected from about 1 millimeter to about 10 millimeters.

18. The process of claim 1, wherein in step (d), said median particle size (D50) is selected from about 2 microns to about 25 microns.

19. The process of claim 18, wherein said median particle size (D50) is selected from about 10 microns to about 20 microns.

20. The process of claim 1, wherein step (c) is conducted, and wherein said first calcining or sintering temperature is selected from about 700° C. to about 1200° C.

21. The process of claim 1, wherein step (c) is conducted, and wherein said first calcining or sintering time is selected from about 2 seconds to about 5 hours.

22. The process of claim 1, wherein step (e) is conducted, and wherein said second calcining or sintering temperature is selected from about 700° C. to about 1200° C.

23. The process of claim 1, wherein step (e) is conducted, and wherein said second calcining or sintering time is selected from about 2 seconds to about 5 hours.

24. The process of claim 1, wherein said supplementary cementitious material has a 7-day strength activity index SAI of at least 75%.

25. The process of claim 1, wherein said supplementary cementitious material has a 28-day strength activity index SAI of at least 75%.

26. The process of claim 1, wherein said supplementary cementitious material is a pozzolan pursuant to ASTM, ACI, and/or AASHTO.

27. The process of claim 1, wherein said supplementary cementitious material contains borax.

28. The process of claim 1, wherein said supplementary cementitious material contains lithium.

29. The process of claim 1, wherein said supplementary cementitious material contains lithium and borax.

30. The process of claim 1, wherein said supplementary cementitious material contains gold, silver, platinum, palladium, rhodium, molybdenum, copper, nickel, aluminum, iron, zinc, phosphorous, silica, sand, clay, slate, shale, or a combination thereof.
